(19) United States
(12) Patent Application Publication
(10) Pub. No.: US 2016/0119980 A1
(43) Pub. Date: Apr. 28, 2016

(54) INDUCTION HEATING TOOL AND METHOD FOR ASSEMBLING A FRONT MODULE TO AN INDUCTION HEATING TOOL

(71) Applicant: ID TOOLS B.V., XG Delft (NL)

(72) Inventor: Dirk van Velden, Delft (NL)

(21) Appl. No.: 14/894,396

(22) PCT Filed: May 27, 2014
(86) PCT No.: PCT/NL2014/050334

§ 371 Date: Nov. 27, 2015

(30) Foreign Application Priority Data
May 28, 2013 (EP) 13169546.2

(51) Int. Cl. H05B 6/14; H05B 6/36

(52) U.S. Cl. CPC H05B 6/14; H05B 6/36

(57) ABSTRACT

The invention relates to an induction heating tool. Said tool comprises a housing provided with a connector for connection with a front module, such as a coil. The connector comprises a first elongated insertion channel for receiving a first plug portion of a front module for an induction heating tool. The connector also comprises a second elongated insertion channel for receiving a second plug portion of said front module. The induction heating tool is arranged for limiting excessive local electrical currents flowing in the elongated contacting surfaces of the connector.

The invention relates an induction heating tool.

Induction heating tools can be used for different purposes. Such tools normally comprise a front module, which may be suitable for generating a high-frequency electric field. Often, induction heating tools are used for heating up an object or one or more components thereof at least partly by means of such high-frequency electric field. It is noted that the object or component may be heated for different purposes, for instance for bonding said object or component to another object or component. The bonding can for example be obtained by welding or brazing and/or by melting a binder agent and/or hardening a binder agent, such as a thermosetting adhesive, under heat. Facilitating the removal of an object from another object may be an alternative purpose of heating an object by means of an induction heating tool. As one example, the induction heating tool can heat up an object to such extent that said object heats up an adjacent binding agent, which may melt due to that. As another example, an object may expand due to heating up, as a result of which said object may be removed using a relative small force. Hence, induction heating tools can for instance be used for facilitating removal of a stuck, e.g. rusted, object from another object relatively easily, such as for instance a nut rusted to a bolt.

Different induction heating tools are known.

There are induction heating tools having a replaceable front module, such as a replaceable coil.

For instance, the front module may be replaceable in order to replace an old or broken front module.

Alternatively or additionally, the front module may be replaceable by another front module having a different configuration in order to make the induction heating tool more versatile. For example, multiple front modules may be sized and/or shaped differently with respect to each other.

A problem associated with known induction heating tools is that it is often relatively difficult, cumbersome and/or error-prone to replaceable a front module. For instance, when two plug portions of the front module are both connected to a housing of a tool by means of a respective set screw, both screws need to be unscrewed before removing a first front module and need to be screwed back after placing a second front module. This may not only be cumbersome, but may also be error-prone. For example, when one of the set screws is not screwed back correctly, it may happen that extreme high currents occur. This can be highly unwanted and even dangerous, for example because it can induce overheating. However, if one of the set screws is screwed back firmly and the other is not, it may seem to a user of the tool that the front module is mounted properly. Hence, it can be very hard, if not impossible, to tell that one of the plug portions is not mounted properly.

An object of the present disclosure is to provide an alternative induction heating tool. It is an object of the present invention to alleviate or solve at least one of the disadvantages mentioned above. In particular, the invention aims at providing an induction heating tool, wherein at least one of the disadvantages mentioned above is counteracted or advantages there above are obtained. In embodiments, the invention aims at providing an induction heating tool, wherein the replacement of a front module is relatively easy, plainly and/or less sensitive to errors. In embodiments, the present invention aims at providing an induction heating tool that can counteract overheating of the induction heating tool, especially overheating due to a front module not mounted properly.

In a first aspect a tool of the present disclosure provides for an induction heating tool, comprising a housing provided with a connector for connection with a front module, such as a coil, wherein the connector comprises a first elongated insertion channel for receiving a first plug portion of a front module for an induction heating tool and a second elongated insertion channel for receiving a second plug portion of said front module, the connector further comprising respective elongated contacting surfaces contacting the respective plug portion when received in the respective channel, the elongated contacting surface comprising an electrically conductive material, wherein the induction heating tool is arranged for limiting excessive local electrical currents flowing in the elongated contacting surfaces of the connector.

By arranging the tool such that excessive local electrical currents flowing in the elongated contacting surfaces of the connector are limited, preferably below a pre-defined level, it is counteracted that, during use of the tool, overheating occurs. Then, a risk of damage to the connector as well as to the plug portions of the front module minimized.

In a further aspect, an induction heating tool is provided with a connector for connection with a front module, such as a coil, wherein the connector comprises a first elongated insertion channel for receiving a first plug portion of a front module for an induction heating tool, and a second elongated insertion channel for receiving a second plug portion of said front module, the connector further comprising respective elongated contacting surfaces contacting the respective plug portion when received in the respective channel, the elongated contacting surface comprising an electrically conductive material, the connector further comprising a first clamp having a first pressing part arranged along the first insertion channel for pressing the first plug portion against the first contacting surface and a second clamp having a second pressing part arranged along the second insertion channel for pressing the second plug portion against the second contacting surface, wherein each pressing part is biased in a direction substantially transverse to the longitudinal direction of the respective insertion channel.

By arranging the pressing part along the respective insertion channel, the plug portion can be pressed into and/or onto a corner and/or bottom side of the channel in a relative flat, even and/or straight manner. As a consequence, the plug portion and the channel, especially by means of its contacting surface, can contact each other over a relative large contact area, thereby counteracting relative high current densities and/or overheating of the induction heating tool. It is noted that in case the pressing part would not be arranged according to this aspect of the invention, i.e. not along the channel, but would for instance be placed beyond or in front of the channel and would there press against a part of the plug portion protruding from said channel, said pressing part could cause the plug portion from pivoting around an end edge of the channel, thereby lifting the plug portion inside the channel. Hence, in such case the plug portion might not be pressed into and/or onto a corner and/or bottom side of the channel in a relative flat, even and/or straight manner. Consequently, in such case the tool would not have the advantages which can be obtained by arranging the pressing part along the respective insertion channel.

Preferably, each pressing part is biased towards the respective contacting surface. As a result, the plug portion can be retained in the channel by means of a corresponding biasing force.

In another aspect, an induction heating tool is provided with a connector for connection with a front module, such as a coil, wherein the connector comprises a first elongated insertion channel for receiving a first plug portion of a front module for an induction heating tool, and a second elongated insertion channel for receiving a second plug portion of said front module, the connector further comprising respective elongated contacting surfaces contacting the respective plug portion when received in the respective channel, the elongated contacting surface comprising an electrically conductive material, the tool comprising a controlling module controlling electrical currents flowing from and towards the elongated contacting surfaces of the connector. Then, the occurrence of extremely high currents can be counteracted. According to aspects, operation of the control module may e.g. be triggered by a measurement of the electrical resistance between the plug portions of the front module on the one hand and the contact areas of the connector on the other hand, and/or by a measurement wherein the temperature of an electric component in the housing such as a transformer is sensed.

Further, the invention relates to a method for assembling a front module to an induction heating tool.

Advantageous embodiments according to the invention are described in the appended claims.

By way of non-limiting example only, embodiments of the present invention will now be described with reference to the accompanying figures in which:

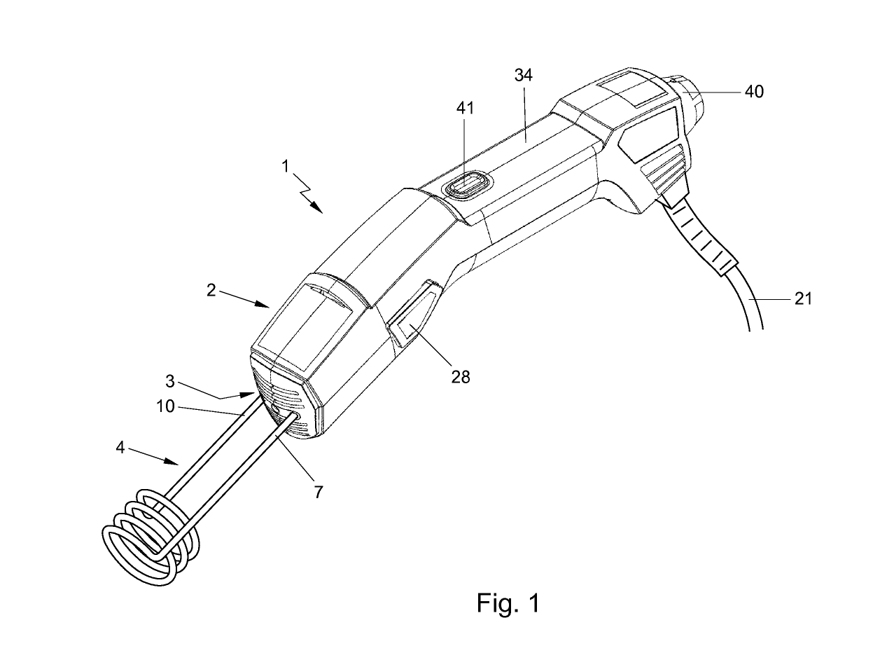

FIG. 1 shows a schematic perspective view of an induction heating tool according to an aspect of the invention;

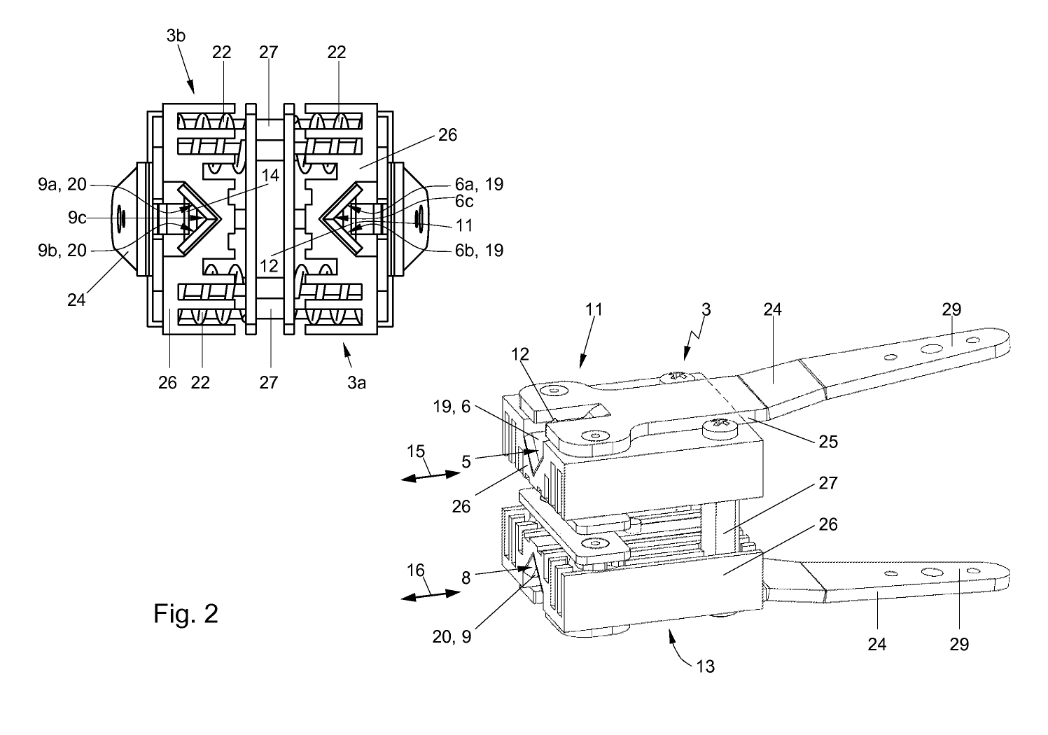

FIG. 2 shows a schematic perspective view and a front view of a connector of the induction heating tool of FIG. 1;

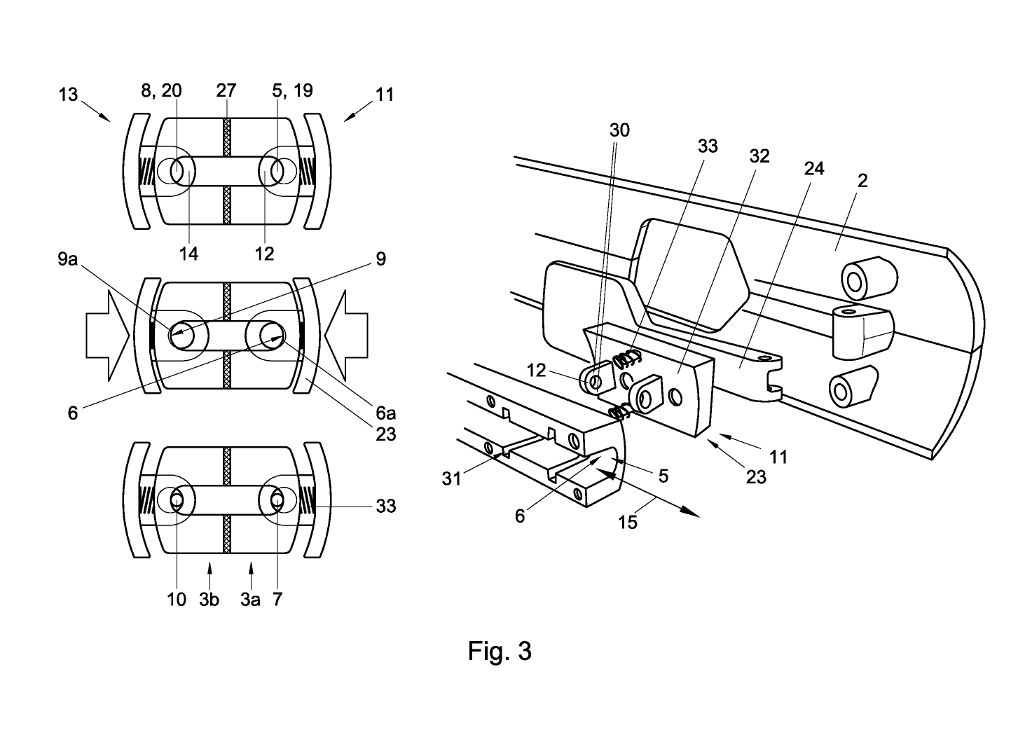

FIG. 3 shows an exploded view and three cross-sectional views of an alternative embodiment of a connector of an induction heating tool according to an aspect of the invention; and

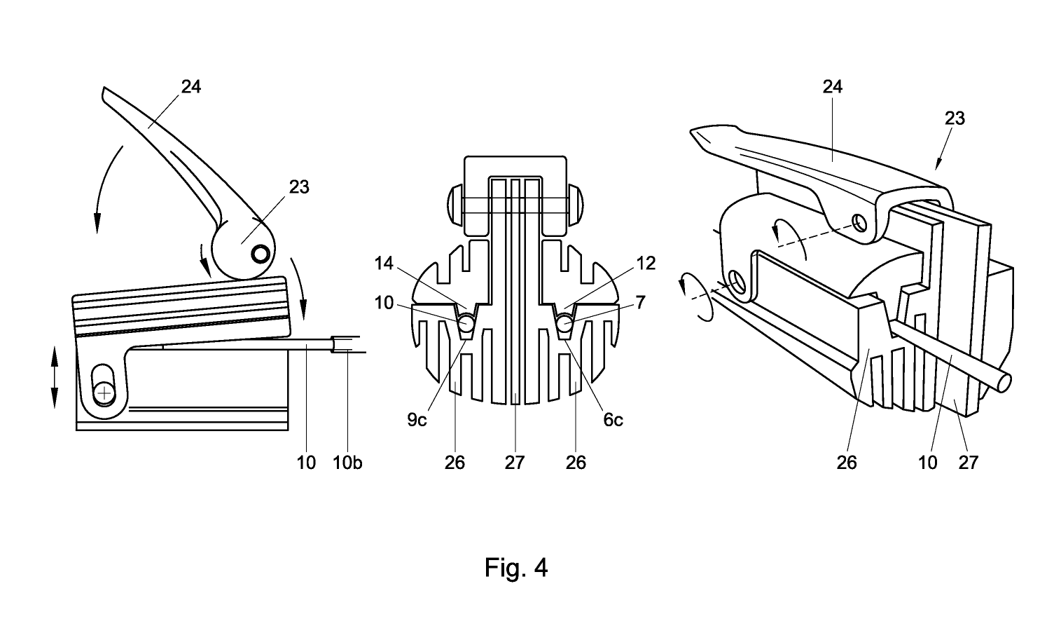

FIG. 4 shows three views of a further embodiment of a connector of an induction heating tool according to an aspect of the invention.

The embodiments disclosed herein are shown as examples only and should by no means be understood as limiting the scope of the claimed invention in any way. In this description the same or similar elements have the same or similar reference signs.

In this description an induction heating tool has to be understood as at least including but not necessarily limited to a power tool for generating a high-frequency electric field inducing eddy currents in electrically conducting objects. The eddy currents locally cause heat in the objects so that the temperature locally increases. The tool has a replaceable front module, such as a replaceable coil. Preferably, the induction heating tool is provided with a multiple number of replaceable front modules, each having specific characteristics, such as a specific shape and/or size. Advantageously, at least a number of the replaceable front modules have coil shaped parts, thereby generating relatively strong local magnetic fields. Further, a front module may be provided including a deformable elongate electric conductor that can be shaped, in principle, in any shape so as to optimally direct the field to the object to be heated. As an example, the deformable electric conductor can be wound around a radial outer surface of a object such as a mainly cylindrical object. Besides, it is noted that the induction heating tool can be implemented as a handheld device or as a self-supporting unit.

FIG. 1 shows a schematic perspective view of an induction heating tool 1 according to an aspect of the invention. The induction heating tool 1 comprises a housing 2 provided with a connector 3 for connection with a front module 4, such as a coil 4. The connector 3 is provided at a front portion of the housing 2. As said above, the induction heating tool 1 can be a handheld tool 1, preferably a power tool 1. It may be provided with a handle 34 or so-called grip portion, preferably at a back portion of the housing, opposite to the front portion of the housing. Here, the induction heating tool 1 is provided with a power cable 21, which may be provided with a plug, for powering the tool 1. However, alternatively or additionally, the tool 1 may be provided with other means of electric energy supply, such as for instance one or more batteries for powering the tool 1.

The power cable 21 has two ends. At a first end, the power cable is connected to electronics in the housing via a fixed connection or via a releasable connection, e.g. using a generally standardized interface. The second end of the power cable 21 includes a connector cooperating with a locally standardized power socket. When using a power cable that is provided, at the first end with a generally standardized interface, the heating tool 1 can be used in a relatively large consumer market. A user may select a power cable 21 provided with a connector, at its second end, that matches locally standardized power sockets.

Preferably, the connector at the first and/or second end is provided with a lock to counteract that the power cable is unintentionally disconnected from the induction heating tool 1.

In the embodiment shown here, the front module 4 comprises a first plug portion 7 and a second plug portion 10. Advantageously, the plug portions 7, 10 can be rod-shaped. For example, the rod-shaped plug portions 7, 10 can have a substantially round cross-section. However, other cross-sections are also possible, such as for instance a substantially elliptical, triangular or rectangular cross-section. Preferably, each plug portion 7, 10 can have a substantially constant cross-section over at least the greater part of its length. Additionally, each plug portion 7, 10 can be provided with a tapered distal end, which may facilitate insertion of said plug potion 7, 10 into the induction heating tool 1. Moreover, alternatively or additionally, the plug portion 7, 10 can be provided with a stop portion (see e.g. the side view in the left of FIG. 4) for limiting the distance that said plug portion can be inserted into the tool 1.

FIG. 2 shows a schematic perspective view and a front view of a connector 3 of the induction heating tool 1 of FIG. 1. The connector 3 comprises a first elongated insertion channel 5 and a first elongated contacting surface 6 for receiving a first plug portion 7 of a front module 4 for an induction heating tool 1. The connector 3 also comprises a second elongated insertion channel 8 and a second elongated contacting surface 9 for receiving a second plug portion 10 of said front module 4. When the plug portions of the front module are received in the respective insertion channels, the respective elongated contacting surfaces 6, 7 contact the respective plug portions. The elongated contacting surfaces comprise an electrically conductive material to conduct electrical currents between the plug portions and a driver circuit accommodated in the housing of the tool. In the shown embodiment, the elongated contacting surfaces form at least a part of the insertion channels. Here, the insertion channels 5, 8 are substantially straight. However, in alternative embodiments they may be shaped differently, for instance curved. Besides, the channels 5, 8 are substantially parallel to each other in the embodiment shown here, for instance to facilitate insertion of substantial parallel plug portions 7, 10 therein. However, in alternative embodiments, the insertion channels can placed such that they are not parallel to each other, for instance when they are arranged for receiving a front module 4 of which the plug portions 7, 10 are not parallel to each other.

Further, the induction heating tool 1 is arranged for limiting excessive local electrical currents flowing in the elongated contacting surfaces of the connector, preferably below a pre-defined level, for counteracting overheating of the induction heating tool 1, e.g. by at least counteracting that, during use of the tool 1, relative high current densities occur at a place where one of the plug portions 7, 10 is in contact with the respective contacting surface 6, 9. The tool 1 may counteract said relative high current densities by means of, during use of said tool 1, pressing the first plug portion 7 against the first contacting surface 6 by means of a first pressing part 12 provided along the first insertion channel 5 and by pressing the second plug portion 10 against the second contacting surface 9 by means of a second pressing part 14 placed along the second insertion channel 8.

Here, the connector 3 comprises a first clamp 11 having a first pressing part 12 arranged along the first insertion channel 5, preferably along its contacting surface, for pressing the first plug portion 7 against the first contacting surface 6. The connector 3 also comprises a second clamp 13 having a second pressing part 14 arranged along the second insertion channel 8, especially along its contacting surface, for pressing the second plug portion 10 against the second contacting surface 9. Here, the connector 3 comprises two substantially mirrored connector parts 3a, 3b. However, in alternative embodiments, the connector 3 does not need to comprises two substantially mirrored connector parts 3a, 3b.

It is noted that the pressing part 12, 14 may comprise a material and/or a surface texture that can counteract that a plug portion 7, 10 slides through the insertion channel 5, 8. For example, the pressing part 12, 14 can comprise an at least partly compressible material and/or a relative rough surface texture. The pressing part may for instance comprise or be made of a rubber material.

Each pressing part 12, 14 is biased in a direction substantially transverse to the longitudinal direction 15, 16 of the respective insertion channel 5, 8. Here, the pressing part 12, 14 is in a direction substantially transverse to said longitudinal direction 15, 16. However, in alternative embodiments, the pressing part 12, 14 can be biased in another direction, such as for instance a direction being substantially diagonal with respect to the longitudinal direction 15, 16 of the respective insertion channel 5, 8.

Advantageously, the insertion channel 5, 8 comprises or is formed by a receiving groove 19, 20 defining the respective elongated contacting surface 6, 9. Preferably, the receiving groove 19, 20 has a substantially constant cross-section, over at least a part of its length. Therefore, the plug portion may be pressed substantially flat into the insertion channel, i.e. substantially parallel with the longitudinal direction of said channel. Hence, a relative large contact surface between said channel and plug portion can be provided for, thereby counteracting relative high current densities.

Here, the receiving groove 19, 20 defines a substantially V-shaped cross-section, seen in the longitudinal direction 15, 16 of the respective insertion channel 5, 8. However, in alternative embodiments, the groove 19, 20 can have a different cross-section, such for instance a U-shaped or semi-circular cross-section. Preferably, the groove 19, 20 is shaped such that the contacting surface 6, 9 comprises surface portions 6a, 6b; 9a, 9b being at an angle with respect to each other, preferably being convergent. By providing a wedge-shaped or prism-shaped groove and/or surface portions 6a, 6b; 9a, 9b being at an angle with respect to each other, a plug portion, especially an elongated plug portion having a round cross-section, can be forced into the groove 19, 20 and can then be clamped in said groove relatively well. Besides, due to said wedge-shaped or prism-shaped groove and/or said angled surface portions 6a, 6b; 9a, 9b, the plug portion can contact the groove over at least two contact lines. Hence, a relative large contact area may be provided for, thereby counteracting relative high current densities.

Preferably, each contacting surface 6, 9 comprises a contact area for contacting a respective plug portion. Said contact area may comprise a material being electrically conductive, such as for instance being or comprising brass, copper or aluminium. The contact area may preferably be formed by the respective surface portion 6a, 6b, 9a, 9b. It is noted that the contacting surfaces 6, 9 can be electrically connected to a power source, such that a current, especially a high frequency high current, is induced to flow through the front module 4 when plug portions 7, 10 thereof are in contact with said contacting surfaces. It is noted that by arranging the induction heating tool 1 for electrically feeding the front module 4 through the contacting surface 6, 9, a relatively large electrically conductive contact area can be provided for, for example since the contacting surface 6, 9 may be relatively large in comparison to a pressing part. Consequently, it may thus be counteracted that a relative high current density occurs, especially when the groove is wedge-shaped or prism-shaped and/or when said groove can contact the plug portion over at least two contact lines.

In embodiments, the contact area can comprise a material having a high resistance to oxidation. Said material can for instance be brass, which also is relatively well electrically conductive.

Here, each groove 19, 20 is formed by a V-shaped strip of electrically conductive material. Each strip can provided in or on a respective heat sink 26, which may be provided with cooling ribs and/or cooling pins. Since both heat sinks 26 may be made of a heat conducting material, such as a metal or alloy, which may be able to conduct electricity, the heat sinks can be spaced apart by means of one or more electrically isolating spacers 27.

It is noted that each pressing part 12, 14 can preferably be biased for pressing the respective plug portion 7, 10 into or towards a bottom 6c, 9c or an edge of the respective receiving groove 6, 9. Here, in the embodiment of FIG. 2, the pressing part 12, 14 is biased for pressing the respective plug portion 7, 10 into and/or towards the bottom edge of the receiving groove 6, 9, which has a V-shaped cross-section in the current embodiment.

In said embodiment shown in FIG. 2, the pressing parts 12, 14 are both biased by biasing means formed by tension springs 22. Alternatively or additionally, other biasing elements 22 can be provided, such as for instance compression springs and/or leaf springs. Preferably, like here, each spring 22 is arranged for working in a direction substantially parallel with the direction in which the respective pressing part 12, 14 is biased. It is noted that although here two springs 22 are provided for moving the respective pressing part 12, 14 towards and/or into a bottom or corner of the groove, in other embodiments an other number of biasing elements may be provided, such as for instance one, three or even more than three biasing elements.

Here, each pressing part 12, 14 is biased towards the respective contacting surface 6, 9. It is noted that this should be understood as including, but not necessary being limited to, that at least a component of the biasing direction is directed towards said respective contacting surface 6, 9. Hence, one pressing part 6; 9 can thus be biased towards both of two angled surface portions 6a, 6b; 9a, 9b of said one contacting surface 6; 9. Due to the biasing of the pressing part 12, 14 towards the respective contacting surface 6, 9, a respective plug portion 7, 10 may be clamped between a pressing part 12, 14 and said respective contacting surface 6, 9. Preferably, the pressing parts 12, 14 are biased such that, during use, the connector 3 can apply clamping forces to the plug portions 7, 10 which are large enough to retain the front module 4 in place during normal use. For example, said forces may be large enough to counteract that the front module 4 moves in the longitudinal direction 15, 16 of one of the or both insertion channels, when a force below a predefined threshold is applied to said front module in said longitudinal direction 15, 16. Said threshold may for example be at least 10 N, 25 N, 50 N, 100 N, 150 N or 250 N.

Besides, the induction heating tool 1, especially the connector 3, can comprise at least one moving means 23 for moving at least one of the pressing parts in a direction substantially opposite to the biasing direction. The moving means 23 may be arranged for manually overcoming the biasing force applied to the pressing part 12, 14. In case the pressing part 12, 14 is biased towards the respective contacting surface 6, 9, said pressing part 12, 14 may be moved away from said contacting surface by means of the moving means 23.

However, in alternative embodiments, such a for instance the embodiment shown in FIG. 4, the pressing parts can be biased away from the contacting surfaces. Then, the moving means 23 may be arranged for moving at least one of the pressing parts in a direction towards the contacting surface in order to clamp a plug portion 7, 10 in the respective channel 5, 8. Advantageously, the tool 1 is then also arranged for holding the moving means 23 in a clamping position in which the plug portion 7, 10 is clamped in the respective channel 5, 8. In embodiments, the moving means 23 may therefore be provided with one or more locks or so-called locking means.

The moving means 23 may comprise a lever 24. Use of such lever 24 may be advantageous, for example in order to amplify a force applied by a user into a force large enough to overcome the biasing force of a biasing element 22 and/or in order to convert the direction of the force applied by the user into a direction directed substantially oppositely. In the embodiment shown here in FIGS. 1 and 2, push buttons 28 are connected to distal ends 29 of the lever 24. By pushing said buttons 28, which may be placed at either side of the housing 2, the levers 24 tilt and the pressing parts 12, 14 connected thereto are moved away from the contacting surfaces, such that the plug portions can then be moved out of the channels and/or into said channels. By subsequently releasing the push buttons 28, the lever tilts back due to the biasing force applied by the biasing elements 22. Hence, the pressing parts can enable that the connector 3 firmly connects the head to the induction heating tool 1 by clamping the plug potions in its insertion channels 5, 8. Here, the lever 24 is connected to the heat sink 26 by means of the tension springs 22 and is pivotable around a pivot axis 25 formed by an edge of the heat sink 26. However, the lever 24 may be connected to other parts of the induction heating tool 1 and/or by different means. For example, the lever 24 may be pivotably connected to the housing 2, such as for instance is shown in the embodiment of FIG. 3.

FIG. 3 shows an exploded view and three cross-sectional views of an alternative embodiment of a connector 3 of an induction heating tool 1 according to an aspect of the invention. Like in the embodiment of FIGS. 1 and 2, also in FIG. 3 the connector 3 comprises a first elongated insertion channel 5 having a first elongated contacting surface 6 for receiving a first plug portion 7 of a front module 4 for an induction heating tool 1. The connector 3 also comprises a second elongated insertion channel 8 having a second elongated contacting surface 9 for receiving a second plug portion 10 of said front module 4. Further, the connector 3 comprises a first clamp 11, here having two first pressing parts 12 arranged along the first insertion channel 5 for pressing the first plug portion 7 against the first contacting surface 6. The connector 3 also comprises a second clamp 13, here having two second pressing parts 14 arranged along the second insertion channel 8 for pressing the second plug portion 10 against the second contacting surface 9. However, another number of pressing parts is possible, such as for instance one or three first pressing parts and/or one or three second pressing parts.

The pressing parts 12, 14 are biased in a direction substantially transverse to the longitudinal direction 15, 16 of the respective insertion channel 5, 8. Here, the pressing parts 12 are connected to a base portion 32 of the clamp 11, 13 by means of one or more spacing parts 30 extending through openings 31 or recesses in the channel 5. Here, biasing elements 33 are formed by compression springs 33 biased in a direction substantially transverse to said longitudinal direction 15, 16.

Moreover, also here the insertion channel 5, 8 comprises or is formed by a receiving U-shaped or semi-circular groove 19, 20 defining the respective elongated contacting surface 6, 9. The channels 5, 8 can be spaced apart by means of one or more non electrically conductive spacers 27.

It is noted that like the insertion channels 5, 8, the contacting surfaces 6, 9 and/or the grooves 19, 20 can preferably be straight. Besides, the contacting surfaces 6, 9 and/or the grooves 19, 20 can be parallel to each other. However, it is noted that the insertion channels 5, 8, the contacting surfaces 6, 9 and/or the grooves 19, 20 do neither necessarily need to be straight, nor necessarily need to be parallel to each other in every embodiment according to the current invention.

Furthermore, the induction heating tool 1, especially the connector 3, can comprise at least one moving means 23 for moving at least one of the pressing parts 12 in a direction substantially opposite to the biasing direction. By pressing the moving means 23 , for instance indirectly pressing them by means of a lever 24, the pressing parts 12 are moved away from the contacting surfaces 6, 9, such that plug portions 7, 10 can be moved out of the channels 5, 8 and/or into said channels. By subsequently releasing the moving means 23, said moving means 23 moves back due to the biasing force applied by the biasing elements 33. Hence, the pressing parts 12, 14 can enable that the connector 3 connects the front module 4 to the induction heating tool 1 by clamping the plug potion 7, 10 in the respective insertion channel 5, 8.

FIG. 4 shows three views of a further embodiment of a connector 3 of an induction heating tool 1 according to an aspect of the invention. In this embodiment, the plug portions 7, 10 are clamped into grooves 6, 9 by means of first and second pressing parts 12, 14. Contrary to the embodiments of FIGS. 1 and 2 and FIG. 3, here, the pressing parts 12, 14 are biased away from the contacting surfaces 6a, 6b, 9a, 9b. Hence, the connector 3 may thus be biased towards a position in which the plug portions 7, 10 can be moved into and/or out of the insertion channels 5, 8. In this embodiment, the tool 1 comprises moving means 23 arranged for moving the pressing parts in a direction towards the contacting surface in order to clamp a plug portion 7, 10 in the respective channel 5, 8. In order to prevent that the biasing elements (not shown) pushes the pressing parts 12, 14 away when said moving means 23 is released, the tool 1 is arranged for holding the moving means 23 in the clamping position. Thereto, the moving means 23 are provided with locking means. Here, said locking means are provided by forming the moving means 23 as an eccentric lever. However, alternatively or additionally other locking means may be provided, such as a bracket, latch or clip. It is noted that although here one moving means, i.e. one lever 24, is provided for moving both pressing parts 12, 14, in embodiments, multiple levers 24 and/or other moving means 23 may be provided. For example, multiple moving means can be provided, of which each can be arranged for moving a respective pressing part 12, 14.

The housing includes a driver circuit for generating resonating electric currents in the front module. The driver circuit typically includes an AD converter, a unit generating high frequency currents, such as a IGBT, and a transformer generating high amplitude currents. The output of the transformer is electrically connected to the elongated contacting surfaces of the connector.

Optionally, means for limiting excessive local electrical currents flowing in the elongated contacting surfaces of the connector , preferably below a pre-defined level, are at least partially implemented in a controlling module provided in the induction heating tool, the controlling module controlling electrical currents flowing from and towards the elongated contacting surfaces of the connector. In a first embodiment, the controlling module is arranged for measuring the electrical resistance between the plug portions of the front module on the one hand and the elongated contacting surfaces of the connector on the other hand. Then, the controlling module is arranged for reducing or blocking the electrical current flowing from the elongated contacting surfaces of the connector towards the plug portions of the front module when the measured electrical resistance is above a pre-defined level. In a second embodiment, the controlling module is arranged for sensing the temperature of an electric component in the housing such as a transformer connected to the elongated contacting surfaces of the connector. Then, the controlling module is arranged for reducing or blocking the electrical current flowing from the elongated contacting surfaces of the connector towards the plug portions of the front module when the measured electrical resistance is above a pre-defined level. Apparently, the controlling module can also be arranged for both measuring the above-mentioned electrical resistance and for sensing the temperature of an electric component in the housing.

Further, the controlling module may be arranged for measuring the amplitude of electrical currents flowing from the elongated contacting surfaces of the connector towards the plug portions of the front module, and for limiting or blocking said currents based on said measurements.

Preferably, the induction heating tool further comprises a cooling fan for cooling electronics in the housing, wherein the cooling fan is arranged for being operational during a period after electrical currents flowing through the elongated contacting surfaces of the connector have terminated, thereby counteracting overheating of components.

The shown induction heating tool further comprises a manually operable interface providing a multiple number of states, preferably pre-programmable, each of the states corresponding with a specific amount of energy to be delivered by the tool, the specific amount of energy preferably being defined by a specific operation time period and a specific operation power. The manually operable interface includes a switch 40 that can be set to a number of positions, e.g. six positions each of them corresponding with a specific state. As an example, a first state is defined such that the tool remains active during 1 minute with 10% of the maximum power, a second state is defined such that the tool remain active during 2 minutes with 25% of the maximum power, etc. Apparently, the switch 40 can be designed such that it can be set to more or less than six states, e.g. eight states or four states. In the shown embodiment, the switch 40 is arranged at a back portion of the tool, near the grip portion 34, opposite to the front portion of the tool. In principle, the switch can be located at another location on the housing of the tool, e.g. between the front portion and the back portion of the tool. The switch 40 is implemented as a turning knob for selecting a desired energy state. However, the switch can also be implemented such that the energy states can be selected by another way of moving the switch, e.g. by pressing or shifting. Further, another manually operable interface can be implemented such as a touch screen or a panel including a multiple number of buttons each corresponding with a state wherein a specific amount of energy is delivered. Further, the parameters defining the specific amount of energy can be chosen in another way, e.g. such that the power varies during operation time, e.g. in a slightly increasing way. The shown tool further comprises another switch 41 on the housing for switching the tool on and off. In another embodiment, the function on/off is realized in another way, e.g. by integration with the manually operable interface described above.

The invention also relates to a method for assembling a front module 4 to an induction heating tool 1. The method comprises a step of providing a front module 4 for an induction heating tool 1, wherein said front module comprises a first plug portion 7 and a second plug portion 10. The method also comprises a step of providing an induction heating tool 1 having a connector 3 comprising a first elongated insertion channel 5 and a second elongated insertion channel 8. The method further comprises a step of inserting the first plug portion 7 into the first insertion channel 5 and inserting the second plug portion 10 into the second insertion channel 8, such that elongated contacting surfaces of the connector contact the first and the second plug portion, respectively, the elongated contacting surfaces comprising an electrically conductive material. The method also includes a step of providing means for limiting excessive local electrical currents flowing in the elongated contacting surfaces of the connector, preferably below a pre-defined level. Preferably, said plug portions 5, 8 are inserted at least partly simultaneously. However, in alternative embodiments, the plug portions may be inserted subsequently. Electrical currents can e.g. be limited by securing that each plug portion 7, 10 and the respective contacting surface 6, 10 are contacting each other over a relative large contact area. Alternatively or additionally, a controlling unit can be provided controlling said electrical currents.

Advantageously, said securing can be done by means of pressing the first plug portion 7 against the first contacting surface 6 by means of a first pressing part 12 provided along the first insertion channel 5 and by pressing the second plug portion 10 against the second contacting surface 9 by means of a second pressing part 12 placed along the second insertion channel 8. Alternatively or additionally, the securing may be done by means of controlling the current supply to the connector 3 at least partly based on a measured electrical resistance between the plug portions 7, 10 and the respective contacting surface 6, 9.

The invention is not restricted to the embodiments described above. It will be understood that many variants are possible.

For example, the housing 2, the connector 3, its insertion channels 5, 8 and/or the grooves 19, 20 can be provided with guiding means, such as tapered guiding surfaces, for facilitating plug portions to be inserted into the insertion channels 5, 8.

Further, the controlling module controlling electrical currents flowing from and towards the elongated contacting surfaces of the connector can be applied in combination with the clamp structure defined in claim 2, or, more generally, in combination with an induction heating tool, comprising a housing provided with a connector for connection with a front module, such as a coil, wherein the connector comprises a first elongated insertion channel for receiving a first plug portion of a front module for an induction heating tool, and a second elongated insertion channel for receiving a second plug portion of said front module, the connector further comprising respective elongated contacting surfaces contacting the respective plug portion when received in the respective channel, the elongated contacting surface comprising an electrically conductive material

These and other embodiments will be apparent to the person skilled in the art and are considered to fall within the scope of the invention as defined by the following claims.

1. An induction heating tool, comprising:
a housing provided with a connector for connection with a front coil-shaped module, the connector including:
a first elongated insertion channel for receiving a first plug portion of the front coil-shaped module;
a second elongated insertion channel for receiving a second plug portion of the front coil-shaped module;
respective elongated contacting surfaces contacting the respective plug portions when received in the respective channels, each of the elongated contacting surfaces containing electrically conductive material,
wherein the induction heating tool is configured to limit excessive local electrical currents flowing in the elongated contacting surfaces of the connector.

2. The induction heating tool according to claim 1, wherein the connector further comprises:
a first clamp having a first pressing part arranged along the first insertion channel for pressing the first plug portion against the first contacting surface, and
a second clamp having a second pressing part arranged along the second insertion channel for pressing the second plug portion against the second contacting surface,
wherein each pressing part is biased in a direction substantially transverse to the longitudinal direction of the respective insertion channel.

3. The induction heating tool according to claim 2, wherein each pressing part is biased towards the respective contacting surface.

4. The induction heating tool according to claim 1, wherein the first and second elongation insertion channels are formed by a receiving groove.

5. The induction heating tool according claim 4, wherein the receiving groove has a V-shaped profile, as seen along a longitudinal direction of the respective insertion channel.

6. The induction heating tool according to claim 5, wherein each pressing part is biased to press the respective plug portion into or towards a bottom or edge of the respective receiving groove having a V-shaped cross-section.

7. The induction heating tool according to claim 1, further comprising:
at least one lever mechanism configured to move at least one of the pressing parts in a direction substantially opposite to the biasing direction.

8. The induction heating tool according to claim 1, wherein the electrically conducting material of the elongated contacting surfaces is anti-corrosive.

9. The induction heating tool according to claim 8, further comprising:
a driver circuit configured to generate resonating electric currents, the driver circuit accommodated in the housing and connected to the contact areas of the connector.

10. The induction heating tool according to claim 1, further comprising:
a controlling module configured to control electrical currents flowing from and towards the elongated contacting surfaces of the connector.

11. The induction heating tool according to claim 10, wherein the controlling module:
operates to measure the electrical resistance between the plug portions of the front coil-shaped module and the elongated contacting surfaces of the connector, and
operates to reduce or block the electrical current flowing from the elongated contacting surfaces of the connector towards the plug portions of the front coil-shaped module when the measured electrical resistance is above a pre-defined level.

12. The induction heating tool according to claim 10, wherein the controlling module:
operates to sense the temperature of an electric component in the housing connected to the elongated contacting surfaces of the connector, and
operates to reduce or block the electrical current flowing from the elongated contacting surfaces of the connector towards the plug portions of the front coil-shaped module when the measured electrical resistance is above a pre-defined level.

13. The induction heating tool according to claim 1, further comprising:
a cooling fan to cool electronic components contained within the housing, wherein the cooling fan is configured to be operational during a period after electrical currents flowing through the elongated contacting surfaces of the connector have terminated.

14. The induction heating tool according to claim 1, further comprising:
a manually operable interface providing a multiple number of programmable states, each of the programmable states corresponding to a specific amount of energy to be delivered by the induction heating tool, the specific amount of energy being based on at least a specific operation time period and a specific operation power.

15. A method for assembling a front module to an induction heating tool, the method comprising:
providing a front module for an induction heating tool, the front module comprising a first plug portion and a second plug portion;
providing an induction heating tool having a connector comprising a first elongated insertion channel and a second elongated insertion channel;
inserting the first plug portion into the first insertion channel and inserting the second plug portion into the second insertion channel, such that elongated contacting surfaces of the connector contact the first and the second plug portion, respectively, the elongated contacting surfaces comprising an electrically conductive material; and
providing a controller to limit excessive local electrical currents flowing in the elongated contacting surfaces of the connector.
